(19) United States
(12) Patent Application Publication
(10) Pub. No.: US 2026/0072381 A1
(43) Pub. Date: Mar. 12, 2026

(54) IMAGE FORMING APPARATUS AND STORAGE MEDIUM

(71) Applicant: Konica Minolta, Inc., Tokyo (JP)

(72) Inventor: Takenori SUENAGA, Tokyo (JP)

(21) Appl. No.: 19/320,521

(22) Filed: Sep. 5, 2025

(30) Foreign Application Priority Data
Sep. 6, 2024 (JP) 2024-153585

(51) Int. Cl. G03G 15/16; G03G 15/00; G03G 15/20

(52) U.S. Cl. CPC G03G 15/1615; G03G 15/162; G03G 15/2057; G03G 15/6561; G03G 15/657; G03G 2215/00405; G03G 2215/00409; G03G 2215/00413; G03G 2215/00565; G03G 2215/00599; G03G 2215/00721; G03G 2215/00746

(57) ABSTRACT

An image forming apparatus includes the following. A medium oscillating mechanism oscillates the recording medium. A medium sensing section senses a position of an end of the recording medium. A belt correction mechanism is configured to correct a position of a belt. A belt sensing section senses the position of the end of the belt. A hardware processor performs first rectification control in which the medium oscillating mechanism rectifies the position of the end of the recording medium based on sensing by the medium sensing section, and second rectification control in which the belt correction mechanism rectifies the position of the end of the belt based on sensing by the belt sensing section. The hardware processor performs a correction to the second rectification control in a case in which the first rectification control is performed with the recording medium straddling both the medium oscillating mechanism and the belt.

### CROSS REFERENCE TO RELATED APPLICATION

The present invention claims priority under 35 U.S.C. § 119 to Japanese Patent Application No. 2024-153585, filed on Sep. 6, 2024, the entire contents of which being incorporated herein by reference.

### BACKGROUND OF THE INVENTION

### Technical Field

The present invention relates to an image forming apparatus and a storage medium.

### Description of Related Art

In an image forming apparatus, a sheet-like recording medium on which image formation is performed may be biased in a direction intersecting a conveyance direction of the recording medium due to various factors.

In a state in which a deviation of the recording medium occurs as described above, a problem occurs in that an image forming position with respect to the recording medium deviates from an original proper position.

Conventionally, the deviated recording medium is sandwiched by registration rollers and oscillated in a medium width direction of the recording medium to correct the deviation (for example, see Japanese Unexamined Patent Publication No. 2019-64810).

The image forming apparatus that forms the image on the recording medium through a plurality of image formation processes uses a belt that comes in contact with the recording medium in part of the processes.

In such a case, a registration roller may perform deviation correction (hereinafter, referred to as registration correction) while the recording medium is in contact with the belt. Thus, the belt is pulled by the sheet and moved, and this may affect the quality of image formation.

### SUMMARY OF THE INVENTION

An object of the present invention is to suppress an influence of movement of a belt due to registration correction.

In order to solve the above-described problem, according to one aspect of the present invention, an image forming apparatus according to one aspect of the present invention is an image forming apparatus that performs image formation on a recording medium by a plurality of processes, the image forming apparatus including:
a medium oscillating mechanism that oscillates the recording medium along a medium width direction intersecting a conveyance direction of the recording medium;
a medium sensing section that senses a position of an end of the recording medium in the medium width direction; and
a belt correction mechanism that is configured to correct a position of a belt in the medium width direction, the belt executing one of processes of the image formation on the recording medium;
a belt sensing section that senses the position of the end of the belt in the medium width direction; and
a hardware processor that performs first rectification control in which the medium oscillating mechanism rectifies the position of the end of the recording medium based on sensing by the medium sensing section, and second rectification control in which the belt correction mechanism rectifies the position of the end of the belt based on sensing by the belt sensing section,
wherein the hardware processor performs a correction to the second rectification control in a case in which the first rectification control is performed with the recording medium straddling both the medium oscillating mechanism and the belt.

According to another aspect of the present invention, a storage medium according to one aspect of the present invention is a non-transitory computer-readable storage medium storing a program that controls a computer of an image forming apparatus including, a medium oscillating mechanism that oscillates a recording medium along a medium width direction intersecting a conveyance direction of the recording medium, a medium sensing section that senses a position of an end of the recording medium in the medium width direction, a belt correction mechanism that is configured to correct a position of a belt in the medium width direction, the belt executing one of processes of the image formation on the recording medium, and a belt sensing section that senses the position of the end of the belt in the medium width direction, the program causing the computer to execute the following:
performing first rectification control in which the medium oscillating mechanism rectifies the position of the end of the recording medium based on sensing by the medium sensing section,
performing second rectification control in which the belt correction mechanism rectifies the position of the end of the belt based on sensing by the belt sensing section, and
performing a correction to the second rectification control in a case in which the first rectification control is performed with the recording medium straddling both the medium oscillating mechanism and the belt.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a configuration diagram schematically showing an image forming apparatus according to the present embodiment;

FIG. 2 is a perspective view of an intermediate transfer belt in a state of being tensioned and supported in the apparatus as viewed from a downstream side in a medium conveyance direction;

FIG. 3 is a rear view of an upper part of the intermediate transfer belt viewed from a back side of a sheet surface of FIG. 1;

FIG. 4 is a perspective view of an upper part of the intermediate transfer belt as viewed from the downstream side in the medium conveyance direction;

FIG. 5 is an explanatory diagram illustrating oscillating processing of a sheet by a registration roller;

FIG. 6 is a perspective view illustrating a configuration of a heating side disposed on an upper side of a fixing device;

FIG. 7 is a perspective view of the same configuration as that of FIG. 6 when viewed from a different direction;

FIG. 8 is a perspective view of the same configuration as that of FIG. 6 when viewed from a further different direction;

FIG. 9 is a block diagram schematically illustrating a configuration of a control system of the image forming apparatus in FIG. 1; and

FIG. 10 is a flowchart of operation control that a controller executes for each part of the image forming apparatus in conveyance of a recording medium.

### DETAILED DESCRIPTION

Hereinafter, one or more embodiments of the present disclosure will be described with reference to the drawings. However, the scope of the invention is not limited to the disclosed embodiments.

Hereinafter, the present embodiment will be described in detail with reference to the drawings. However, the scope of the invention is not limited to the illustrated examples.

### Outline of Each Configuration of Image Forming Apparatus

First, the configuration of an image forming apparatus 100 according to the present embodiment is described below.

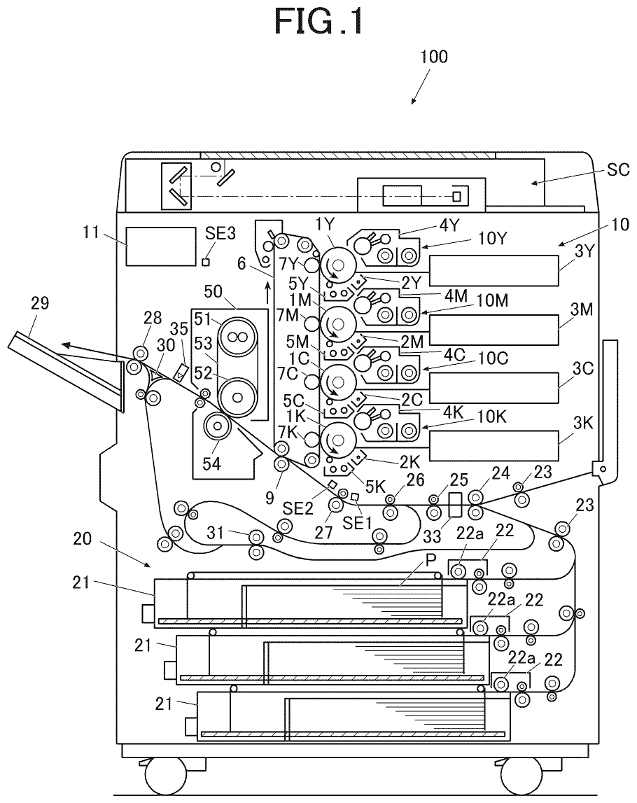

FIG. 1 is a configuration diagram schematically showing the image forming apparatus 100 according to the present embodiment. The image forming apparatus 100 is, for example, the electrophotographic image forming apparatus 100 such as a copier. The image forming apparatus 100 is a tandem-type image forming apparatus that forms a color image by arranging a plurality of photoreceptors in a vertical direction so as to face one intermediate transfer belt. However, the image forming apparatus being the apparatus that forms the color images and that is the tandem-type are merely examples, and other image forming apparatuses may be exemplified as the embodiment.

A recording medium P on which the image forming apparatus 100 performs image formation is not limited to various types of recording sheets such as plain paper. The recording medium P includes all sheet-like recording media on which image formation can be performed, such as cut paper, continuous paper, long paper, and OHP sheets.

The image forming apparatus 100 includes a document reading device SC, an image forming section 10, a fixing device 50, an image reading section 35, a medium conveyance section 20, and a controller 11 (hardware processor). In the image forming apparatus 100, these are housed in one housing.

### Document Reading Device

The document reading device SC performs scanning exposure of an image of a document by an optical system of a scanning exposure device and reads reflected light by a line image sensor to obtain an image signal. The image signal is subjected to processing such as A/D conversion, shading correction, and compression, and is then input as image data to the controller 11. Note that the image data input to the controller 11 is not limited to that read by the document reading device SC. The image data may be, for example, data received from a personal computer or another image forming apparatus through the communication section 13.

### Image Forming Section

The image forming section 10 includes four sets of image forming units 10Y, 10M, 10C, and 10K, an intermediate transfer belt 6, and a secondary transfer roller 9. The image forming units 10Y, 10M, 10C, and 10K are image forming units of respective colors of Y, M, C, and K. “Y”, “M”, “C”, and “K” included in the reference numerals indicate those related to image formation of the respective colors of yellow, magenta, cyan, and black.

The image forming unit 10Y includes a photosensitive drum 1Y, and a charging section 2Y, an optical writing section 3Y, a developing device 4Y, and a drum cleaner 5Y which are arranged around the photosensitive drum 1Y.

The image forming unit 10M includes a photosensitive drum 1M, and a charging section 2M, an optical writing section 3M, a developing device 4M, and a drum cleaner 5M which are arranged around the photosensitive drum 1M.

The image forming unit 10C includes a photosensitive drum 1C, and a charging section 2C, an optical writing section 3C, a developing device 4C, and a drum cleaner 5C which are arranged around the photosensitive drum 1C.

The image forming unit 10K includes a photosensitive drum 1K, and a charging section 2K, an optical writing section 3K, a developing device 4K, and a drum cleaner 5K which are arranged around the photosensitive drum 1K.

The surfaces of the photosensitive drums 1Y to 1K are uniformly charged by the charging sections 2Y to 2K. Furthermore, scanning exposure by the optical writing sections 3Y to 3K forms latent images on the photosensitive drums 1Y to 1K. Furthermore, the developing devices 4Y to 4K develop the latent images on the photosensitive drums 1Y to 1K with toner to visualize the latent images. Thus, toner images in predetermined colors corresponding to yellow, magenta, cyan, and black are formed on the photosensitive drum 1Y to 1K, respectively. The toner images formed on the photosensitive drums 1Y to 1K are sequentially transferred to the intermediate transfer belt 6 by the primary transfer rollers 7Y, 7M, 7C, and 7K.

The intermediate transfer belt 6 is a belt that bears the toner image and performs an intermediate transfer process of secondarily transferring the toner image onto a recording medium P.

The toner image in the respective colors transferred onto the intermediate transfer belt 6 is transferred onto the recording medium P by the secondary transfer roller 9. The secondary transfer roller 9 is a pressure contact member that forms a nip portion (hereinafter referred to as a “transfer nip portion”) by being disposed in pressure contact with the intermediate transfer belt 6.

### Image Forming Section: Periphery of Intermediate Transfer Belt

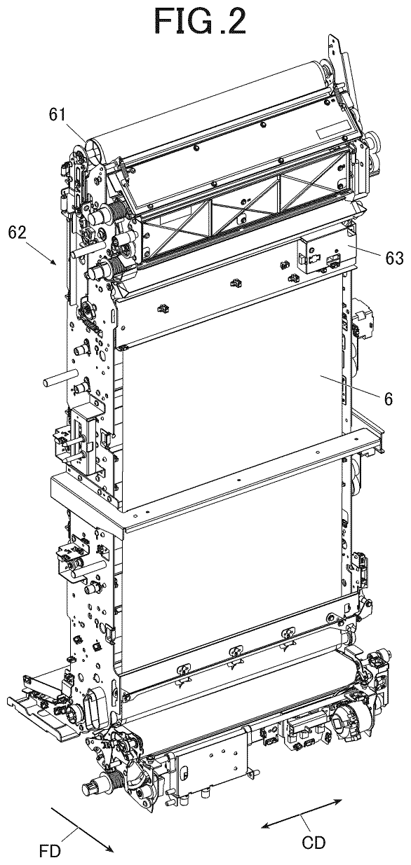

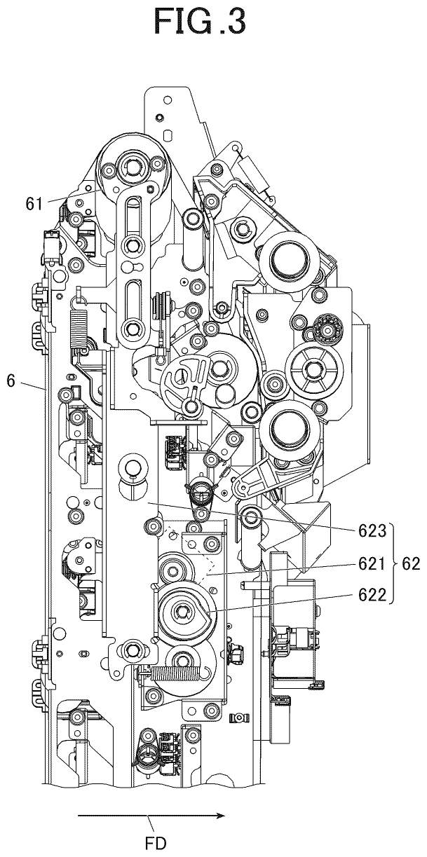

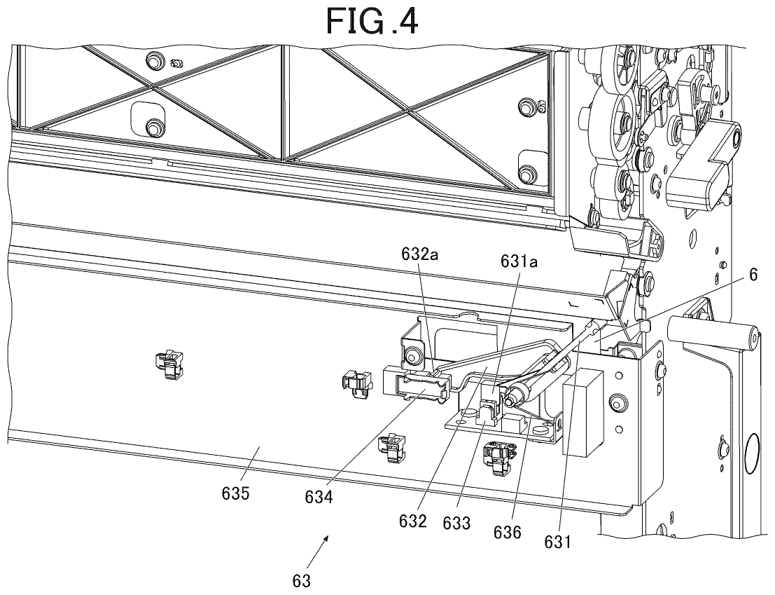

FIG. 2 is a perspective view of the intermediate transfer belt 6 in a state of being tensioned and supported in the apparatus as viewed from a downstream side in a medium conveyance direction FD. FIG. 3 is a rear view of an upper part of the intermediate transfer belt 6 viewed from a back side of a sheet surface of FIG. 1. FIG. 4 is a perspective view of an upper part of the intermediate transfer belt 6 as viewed from the downstream side in the medium conveyance direction FD.

The medium conveyance direction FD is a sub-scanning direction and is a direction parallel to the conveyance direction in a case in which the recording medium P is conveyed in the medium conveyance section 20 in an appropriate orientation. Furthermore, in the following description, a direction which is parallel to the recording medium P and intersects the medium conveyance direction FD is referred to as a medium width direction CD. More specifically, the medium width direction CD is a direction orthogonal to the medium conveyance direction FD. The appropriate orientation is an orientation in which one side end portion of the recording medium P in the medium width direction CD is parallel to the conveyance direction planned for the medium conveyance section 20.

Each configuration of the image forming apparatus 100 may be described using the medium conveyance direction FD and the medium width direction CD.

The intermediate transfer belt 6 is formed of an endless annular belt which is made of polyimide as a base material and whose surface is coated with a release coating.

Part or all of the plurality of rollers around which the intermediate transfer belt 6 is stretched may be rotationally driven by a motor.

The upper side of the intermediate transfer belt 6 is stretched in a mountain shape by the three rollers, and the lower side is stretched by the two rollers. Note that the number of rollers around which the intermediate transfer belt 6 is stretched and supported is merely an example, and can be increased or decreased within a range of two or more.

One of the lower side rollers forms a nip portion with the above-described secondary transfer roller 9 to transfer the toner image from the intermediate transfer belt 6 onto the recording medium P.

Among the three upper side rollers, the roller located at the apex is a steering roller 61. Basically, rotation shafts of the five rollers including the steering roller 61 are oriented in a direction parallel to the medium width direction CD.

The rotation shaft of the steering roller 61 can be tilted by a first steering mechanism 62 as a belt correction mechanism. The steering roller 61 can perform position correction of the intermediate transfer belt 6 in the medium width direction CD by tilting of the rotation shaft thereof.

As illustrated in FIG. 3, the first steering mechanism 62 can turn an outer periphery cam 622 to an arbitrary angle via a deceleration mechanism by using a steering motor 621 as a drive source. One end of the steering roller 61 in the medium width direction CD is rotatably supported by a lever member 623 extending in the up-down direction.

The outer periphery cam 622 has a shape in which an outer diameter increases or decreases along a circumferential direction. An outer periphery of the outer peripheral cam 622 is in contact with a lower side end portion of a lever member 623 on a downstream side in the medium conveyance direction FD. Therefore, when the outer periphery cam 622 rotates, the upper end portion of the lever member 623 oscillates, and the rotation shaft of the steering roller 61 tilts.

When the rotation shaft of the steering roller 61 is tilted, in accordance with a tilting direction, the intermediate transfer belt 6 moves toward any one direction in the medium width direction CD. Therefore, when the intermediate transfer belt 6 is deviated in any one direction in the medium width direction CD, the deviation can be rectified by moving the intermediate transfer belt 6 in the opposite direction.

A deviation amount of the intermediate transfer belt 6 in the medium width direction CD can be detected by a first deviation sensing device 63 as a belt sensing section.

The first deviation sensing device 63 detects, in an upper portion of the intermediate transfer belt 6, a position in the medium width direction CD for an end portion on one side in the medium width direction CD.

As illustrated in FIG. 4, the first deviation sensing device 63 includes a sensing arm 631, an oscillating arm 632, a first sensor 633, a second sensor 634, and a support plate 635.

The sensing arm 631 is supported so as to be rotatable relative to the support plate 635. A rotation end portion of the sensing arm 631 is in contact with one end portion of the intermediate transfer belt 6 in the medium width direction CD. A weak spring pressure is applied to the sensing arm 631 by a spring 636 so as to maintain the contact state with the intermediate transfer belt 6.

The oscillating arm 632 is connected to the sensing arm 631 so as to integrally rotate. The sensing arm 631 is provided with a plate-shaped detected section 631a to be detected by the first sensor 633. Furthermore, the oscillating arm 632 is provided with a plate-shaped detected section 632a to be detected by the second sensor 634.

The first and second sensors 633 and 634 include detection elements that optically detect the respective detected sections 631a and 632a. Each detection element may detect the presence or absence of the detected sections 631a and 632a in its detection range. Alternatively, each detection element may be, like a line sensor, for detecting a position and an amount of movement of the detected sections 631a and 632a in a predetermined direction.

In the former case, each of the detection elements can judge the suitability of the position of the intermediate transfer belt 6 in the medium width direction CD based on a combination pattern of the presence and absence of the detected sections 631a and 632a. For example, one of the combination patterns indicates a state of being at an appropriate position in the medium width direction CD of the intermediate transfer belt 6. In addition, another pattern indicates deviation of the intermediate transfer belt 6 to one side in the medium width direction CD. Furthermore, still another pattern indicates deviation of the intermediate transfer belt 6 to the other side in the medium width direction CD.

Further, in the latter case, it is possible to detect the deviation of the intermediate transfer belt 6 from the proper position in the medium width direction CD from detected amounts of the detected sections 631a and 632a. Thus, it is possible to detect whether the position of the intermediate transfer belt 6 in the medium width direction CD is appropriate, how much deviation to one side or the other side occurs, and the like.

The controller 11 as a control device or a hardware processor performs the second rectification control for the first steering mechanism 62 based on the sensing by the first deviation sensing device 63.

The second rectification control for the first steering mechanism 62 performed by the controller 11 will be separately described later.

### Medium Conveyance Section

The medium conveyance section 20 conveys the recording medium P along a conveyance route of the recording medium P. The recording medium P is stored in a supply tray 21, and the recording medium P is taken in by supply rollers 22a of a feed section 22 and fed to the conveyance route. Alternatively, the recording medium P is supplied from the outside of the image forming apparatus 100 through an external supply opening and is sent to the conveyance route. For example, the recording medium P formed of a long sheet is supplied to the image forming apparatus 100 via an external supply opening.

In the conveyance route, a plurality of conveyance units for conveyance of the recording medium P are provided on the upstream side of the transfer nip portion of the secondary transfer roller 9. Each conveyance means is composed of a pair of rollers pressed against each other. Each conveyance means conveys a recording medium P by at least one of the rollers being rotationally driven through a drive mechanism mainly composed of an electric motor. Furthermore, the pair of rollers constituting each conveyance means is configured such that the state between the rollers can be switched between a pressed contact state and a separated state.

Intermediate conveyance rollers 23 to 25, a loop roller 26, and a registration roller 27 are provided from the upstream to the downstream side of the conveyance route of the recording medium P. These conveyance means may be a combination of belts or a combination of a belt and a roller, other than a pair of rollers.

### Medium Conveyance Section: Registration Roller

The recording medium P supplied to the conveyance route is sequentially conveyed by a plurality of intermediate conveyance rollers 23 to 25 and a loop roller 26 provided from the upstream to the downstream side. Then, a leading end of the recording medium P is abutted against the registration roller 27 in a rotation stop state. Furthermore, the loop roller 26 continues to rotate for a predetermined amount of time. Thus, a loop is formed in the recording medium P. Due to the effect of loop formation, a skew of the leading end of the recording medium P is rectified. In other words, the tilt of the recording medium P is subjected to skew rectification. That is, the leading end portion of the recording medium P becomes parallel to the nip portion of the registration roller 27 which is parallel to the medium width direction CD, and the skew is rectified.

Next, the registration roller 27 starts rotating at a predetermined timing so as to be synchronized with the toner image held on the intermediate transfer belt 6. At this time, the intermediate conveyance rollers 23 to 25 and the loop roller 26 are switched from the pressed contact state to the separated state. That is, when the intermediate conveyance rollers 23 to 25 and the loop roller 26 are brought into a separated state, the recording medium P is conveyed by the registration roller 27 alone. The registration roller 27 conveys the recording medium P to the transfer nip portion between the intermediate transfer belt 6 as an image bearing member and the secondary transfer roller 9 as a transfer section. At that time, the registration roller 27 serving as an oscillating roller performs oscillating processing, which will be described later, while conveying the recording medium P.

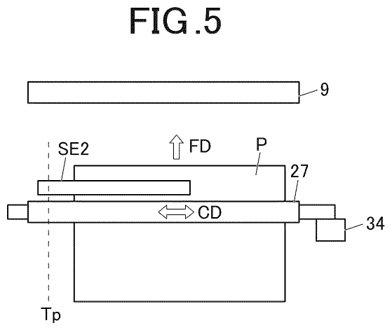

FIG. 5 is an explanatory diagram illustrating the oscillating processing of the recording medium P by the registration roller 27. The registration roller 27 is configured to be able to oscillate in the medium width direction CD. Aside from a registration motor 271 that rotationally drives, a medium oscillating mechanism 34 that uses the motor as a drive source is connected to the registration roller 27. The registration roller 27 is driven by the medium oscillating mechanism 34 and can move in the medium width direction CD with a predetermined home position as a starting point.

The registration roller 27 moves along the medium width direction CD in accordance with a passage period in which the recording medium P passes therethrough. Thus, the conveyed recording medium P can be moved along the medium width direction CD (oscillating processing). Hereinafter, the movement of the recording medium P along the medium width direction CD by the registration roller 27 is referred to as “oscillating of the recording medium P”.

Thus, the registration roller 27 adjusts a conveyance position of the recording medium P in the medium width direction CD so as to match the position of the toner image to be transferred. Here, a position in the medium width direction CD where a side edge portion of the recording medium P should pass is referred to as a target position Tp. When the side edge of the recording medium P passes the target position Tp, it is a position where the positional relationship between the recording medium P and the toner image is expected to be optimal. For example, it is a position where a width direction center of the recording medium P and a width direction center of the toner image coincide with each other.

The registration roller 27 is subjected to first rectification control which will be described later. Thereby, the registration roller 27 adjusts the conveyance position of the recording medium P in the medium width direction CD so that the side end portion of the recording medium P becomes the target position Tp. The position of the toner image where the positional relationship between the recording medium P and the toner image is optimum is referred to as an optimum image position.

The conveyance route is provided with a registration sensor SE1 and a position sensing sensor SE2. The controller 11 controls the operation of the registration roller 27 based on a detection of the sensor SE1.

In the conveyance route, a registration sensor SE1 is disposed between the registration roller 27 and the loop roller 26. The registration sensor SE1 detects the arrival of the leading end of the recording medium P at a position a predetermined distance before the registration roller 27. A detection result of the registration sensor SE1 is used for determination of a rotation start timing of the registration roller 27.

In the conveyance route, a position sensing sensor SE2 as a medium sensing section is provided on the downstream side of the registration roller 27 in the medium conveyance direction FD. The position sensing sensor SE2 is a sensing section that senses the position of the side edge portion of the recording medium P in the medium width direction CD. The position sensing sensor SE2 is, for example, a linear image sensor in which a plurality of light receiving elements are linearly arranged along the medium width direction CD. The sensing result of the position sensing sensor SE2 is output to the controller 11, and is used to determine oscillating control information of the registration roller 27 in the oscillating processing. Furthermore, the operation of the medium oscillating mechanism 34 is controlled based on the determination.

The controller 11 executes first rectification control for causing the medium oscillating mechanism 34 to rectify the position of the edge of the recording medium P based on detection by the position sensing sensor SE2.

The first rectification control for the medium oscillating mechanism 34 performed by the controller 11 will be separately described later.

### Medium Conveyance Section: Media Sensor

On the conveyance route, between the intermediate conveyance roller 24 and the intermediate conveyance roller 25, a media sensor 33 (medium sensor) as a medium sensing section is provided.

The media sensor 33 senses physical property values of the recording medium P. The media sensor 33 includes a thickness sensor, a moisture percentage sensor, a basis weight sensor, and a stiffness sensor. The thickness sensor detects a thickness of the recording medium P. The moisture percentage sensor detects moisture percentage of the recording medium P. The basis weight sensor detects basis weight of the recording medium P. The stiffness sensor detects stiffness of the recording medium P.

### Fixing Device

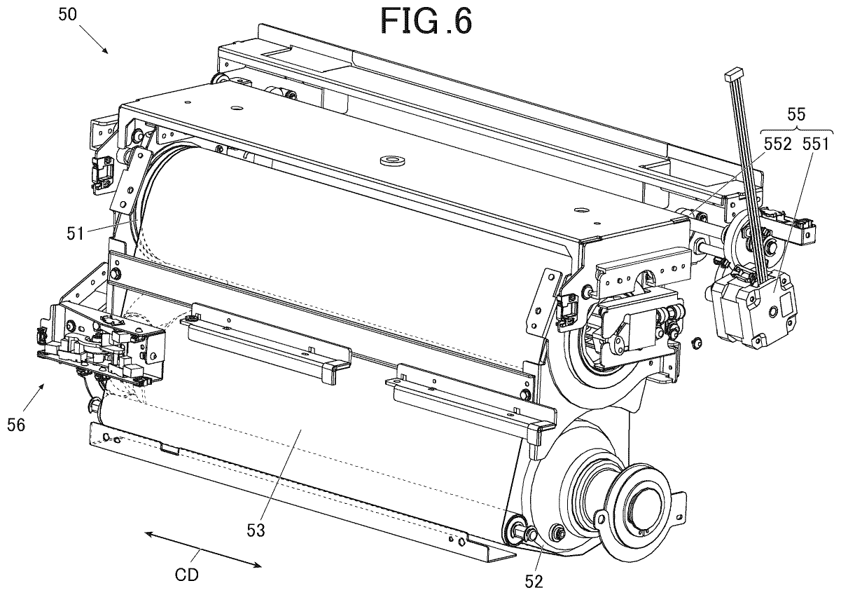

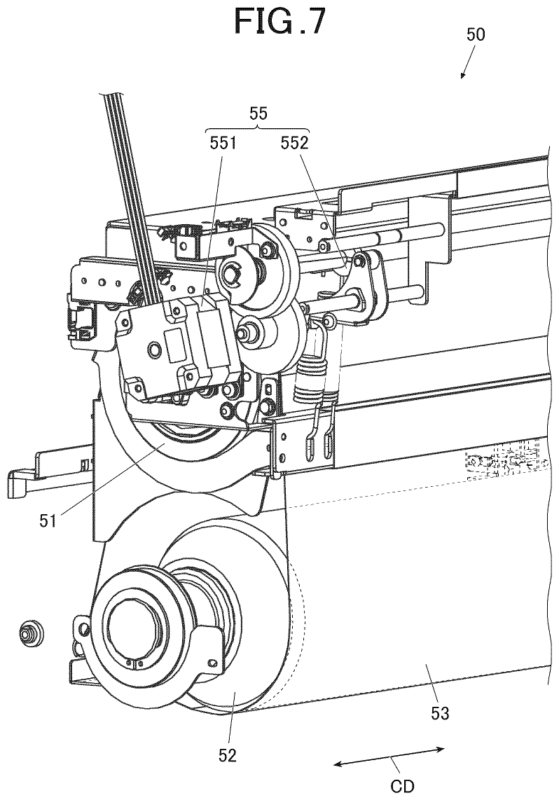

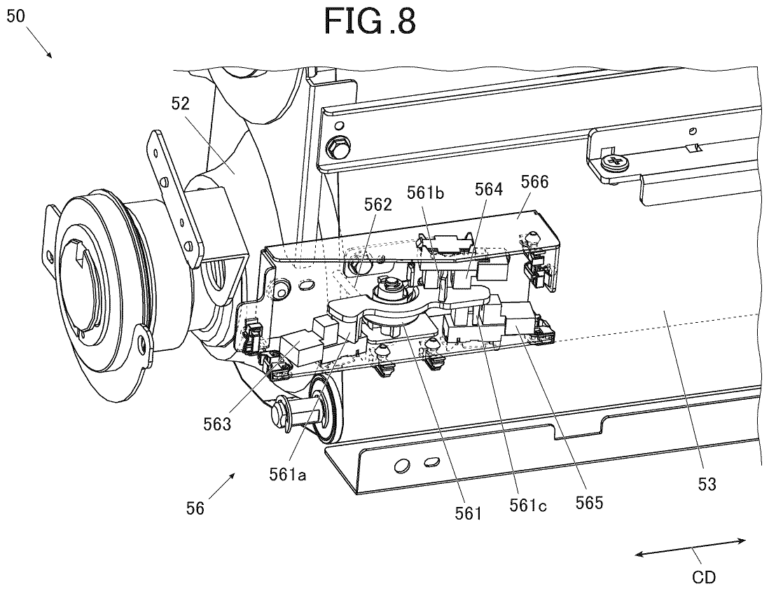

FIG. 6 is a perspective view showing the structure of the heating side disposed on the upper side of the fixing device 50, and FIG. 7 is a perspective view of the same structure as that of FIG. 6 as viewed from a different direction. FIG. 8 is a perspective view of the same configuration as that in FIG. 6 when viewed from a further different direction.

The fixing device 50 is a device that performs fixing processing on the recording medium P onto which the toner image has been transferred, that is, the recording medium P sent out from the transfer nip portion.

The fixing device 50 includes, for example, first and second heating rollers 51 and 52, a fixing belt 53, a pressure roller 54, a second steering mechanism 55, and a second deviation sensing device 56.

The first and second heating rollers 51 and 52 are disposed above the conveyance route of the recording medium P in a state where, basically, the rotation shafts thereof are parallel to the medium width direction CD.

The first heating roller 51 incorporates a heater which is a heating source and is arranged on the upper side of the second heating roller 52.

The fixing belt 53 is stretched between the first heating roller 51 and the second heating roller 52.

The second heating roller 52 forms a nip portion with the pressure roller 54 via the fixing belt 53 and performs fixing of a recording medium P passing through the nip portion.

The pressure roller 54 is arranged so as to be in pressure-contact with the second heating roller 52 via the fixing belt 53 in a state where the rotation shaft is parallel to the medium width direction CD. Any one of the rollers 51, 52, and 54 may be a target, but a configuration in which the pressure roller 54 is rotationally driven by the motor is illustrated.

The fixing belt 53 is a belt that performs a process of fixing the toner image to the recording medium P. The fixing belt 53 is formed of the endless annular belt which is made of polyimide as the base material and whose surface is coated with the release coating.

The fixing device 50 performs fixing of the toner image to the recording medium P through the actions of pressurization and heating in the conveyance process of the recording medium P.

Then, the second steering mechanism 55 can tilt the rotation shaft with respect to the first heating roller 51. The first heating roller 51 can perform position correction of the fixing belt 53 in the medium width direction CD by tilting of the rotation shaft thereof.

As illustrated in FIG. 7, the second steering mechanism 55 can turn an outer periphery cam 552 to an arbitrary angle via a deceleration mechanism by using a steering motor 551 as the drive source. When the outer periphery cam 552 rotates, one end portion of the first heating roller 51 in the medium width direction CD tilts in a predetermined direction.

When the rotation shaft of the first heating roller 51 is tilted, in accordance with the tilting direction, the fixing belt 53 moves in any one direction in the medium width direction CD. Therefore, when the fixing belt 53 is deviated in any one direction in the medium width direction CD, the deviation can be rectified by moving the fixing belt 53 in the opposite direction.

The deviation amount of the fixing belt 53 in the medium width direction CD can be detected by the second deviation sensing device 56 as the belt sensing section.

As shown in FIG. 8, the second deviation sensing device 56 detects, in the upper portion of the fixing belt 53, the position in the medium width direction CD for the end portion on one side in the medium width direction CD.

The second deviation sensing device 56 includes a sensing arm 561, a first sensor 563, a second sensor 564, a third sensor 565, and a support plate 566.

The sensing arm 561 is supported so as to be rotatable relative to the support plate 566. The sensing arm 561 includes a round rod-shaped sensing piece 562 that abuts one end portion of the intermediate transfer belt 6 in the medium width direction CD. Further, a weak spring pressure is applied to the sensing arm 561 by a spring (not shown) so as to maintain the contact state with the fixing belt 53.

The sensing arm 561 is provided with plate-shaped detected sections 561a to 561c to be detected by the first to third sensors 563 to 565.

The first to third sensors 563 to 565 include detection elements that optically detect the respective detected sections 561a to 561c. Each of the detection elements may detect the presence or absence of the detected sections 561a to 561c in its detection range. Alternatively, each detection element may be, like a line sensor, for detecting a position and an amount of movement of the detected sections 561a to 561c in a predetermined direction.

In the former case, each of the detection elements detects a pattern of combinations of presence and absence of the detected sections 561a to 561c. Then, the suitability of the position of the fixing belt 53 in the medium width direction CD can be judged by the detected individual patterns. For example, one of the combination patterns indicates a state of being positioned within an appropriate range in the medium width direction CD of the fixing belt 53. Further, another pattern indicates deviation of the fixing belt 53 to one side in the medium width direction CD. Furthermore, still another pattern indicates deviation of the fixing belt 53 to the other side in the medium width direction CD.

In the latter case, the position of the fixing belt 53 in the medium width direction CD can be detected from the detected amounts of the detected sections 561a to 561c that are detected. Thus, it is possible to detect whether the position of the fixing belt 53 in the medium width direction CD is within an appropriate range, how much amount of deviation to one side or the other side has occurred, and the like.

The controller 11 performs the second rectification control for the second steering mechanism 55 based on the sensing of the second deviation sensing device 56.

The second rectification control for the second steering mechanism 55 performed by the controller 11 will be separately described later.

### Image Reading Section

The image reading section (ICCU) 35 includes, for example, a linear image sensor (e.g., CCD line sensor), an optical system, and a light source. The image reading section 35 reads the recording medium P to which the toner image is transferred and outputs the read image to the controller 11. Note that in the present embodiment, the image reading section 35 can measure a color of the toner image on the recording medium P. However, the image reading section 35 is not particularly limited as long as it can recognize at least a region of the recording medium P and a region of the toner image. Furthermore, in the present embodiment, it is assumed that the image reading section 35 is arranged on the downstream side of the fixing device 50 and on the front side (close side) where the conveyance route is switched by the switching gate 30. However, the image reading section 35 may be disposed downstream of the secondary transfer roller 9 and at a position where both sides of the recording medium P can be read. The recording medium P may be at a position where one side can be read at a time.

Further, the image reading section 35 may be disposed downstream of the image forming apparatus 100 as an optional device.

The recording medium P on which the fixing processing has been performed by the fixing device 50 is read by the image reading section 35. Next, the recording medium P is ejected by an ejection roller 28 to an ejection tray 29 mounted on an external side surface of the housing. Furthermore, when the image formation is performed also on the back surface of the recording medium P, the recording medium P on which the image formation has been performed on the front surface of the sheet is read by the image reading section 35. Next, the recording medium P is conveyed to a reversing roller 31 located below by a switching gate 30. The reversing roller 31 nips a trailing end of the conveyed recording medium P and then feeds the recording medium P backward, thereby reversing the recording medium P and feeding the recording medium P to a re-supply conveyance route. The recording medium P sent to the re-supply conveyance route is conveyed to the registration roller 27 by a plurality of re-supply conveyance means. Furthermore, the recording medium P is returned to the transfer nip portion via the registration roller 27. Note that the ejection roller 28, the switching gate 30, the reversing roller 31, and the re-supply conveyance means also constitute the above-described medium conveyance section 20.

### Control System of Image Forming Apparatus

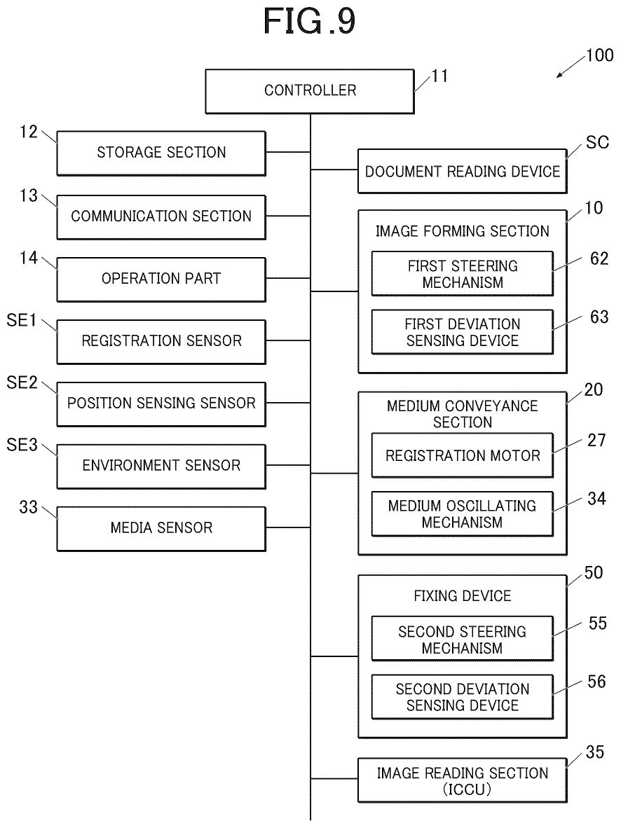

FIG. 9 is a block diagram schematically illustrating a configuration of a control system of the image forming apparatus 100 according to the present embodiment.

The controller 11 is connected to the storage section 12, the communication section 13, the operation part 14, the document reading device SC, the image forming section 10, the medium conveyance section 20, and the fixing device 50. Further, the controller 11 is connected to an image reading section 35, a registration sensor SE1, a position sensing sensor SE2, an environment sensor SE3, and a media sensor 33. The controller 11 includes a CPU, a RAM, and the like.

The CPU of the controller 11 reads a system program and various processing programs stored in the storage section 12 and deploys the programs to the RAM. Further, the controller 11 centrally controls the operation of each unit of the image forming apparatus 100 in accordance with the deployed program.

For example, when a job execution instruction for image formation is input by the operation part 14, the controller 11 executes an image formation job. Specifically, the controller 11 performs control to form a toner image on the recording medium P based on the image data input from the document reading device SC or the communication section 13.

In addition, all of first rectification control, second rectification control, and correction processing for the second rectification control, which will be described later, are based on the processing program stored in the storage section 12. These control and processing are realized by the CPU of the controller 11 executing each processing program.

The storage section 12 includes a non-volatile semiconductor memory and a hard disk drive (HDD). The storage section 12 stores various programs to be executed by the controller 11, as well as parameters, data, and the like necessary for the various sections.

The communication section 13 includes various interfaces and is connected to an external device. The various interfaces are a network interface card (NIC), a Modulator-DEModulator (MODEM), a universal serial bus (USB), and the like.

The operation part 14 outputs various kinds of information set by a user to the controller 11. As the operation part 14, for example, a touch screen on which an input operation can be performed according to information displayed on the display can be used.

The user can set setting information of image formation through the operation part 14. The setting information includes image density, magnification, whether to perform double-sided printing, and conveyance conditions of the recording medium P. Further, the conveyance conditions of the recording medium P includes a conveyance speed of the recording medium P, a type of the recording medium P (for example, size, paper quality, and the like), and a supply tray to be used. The size of the recording medium P includes both the size in the medium conveyance direction FD and the size in the medium width direction CD. The setting information for image formation are stored in the storage section 12.

Note that the thickness, moisture percentage, basis weight, and stiffness of the recording medium P detected by the above-described media sensor 33 are also stored as the conveyance conditions of the recording medium P in the storage section 12. The media sensor 33 periodically repeats detection. Therefore, the setting information of the thickness, the moisture percentage, the basis weight, and the stiffness of the recording medium P in the storage section 12 is sequentially updated.

In addition, the user can input a job execution command or an operation instruction in the adjustment mode through the operation part 14. Further, the controller 11 can display various messages to the user via the operation part 14 by controlling the operation part 14.

The environment sensor SE3 includes, for example, a temperature sensor and a moisture sensor, senses temperatures and moisture in the housing of the image forming apparatus 100, and outputs the sensing result to the controller 11.

### Control Executed by Controller: First Rectification Control for Medium Oscillating Mechanism

The controller 11 executes, on the medium oscillating mechanism 34, first rectification control (medium correction control) for rectifying deviation of the recording medium P in the medium width direction CD during conveyance of the recording medium P.

When sensing the deviation of the recording medium P in the medium width direction CD with respect to the target position Tp, the controller 11 controls the medium oscillating mechanism 34 such that the deviation is eliminated. The deviation of the recording medium P in the medium width direction CD with respect to the target position Tp is detected by the position sensing sensor SE2.

Hereinafter, for convenience of explanation, one side in the medium width direction CD is referred to as “left” and the other side is referred to as “right”.

The controller 11 periodically monitors the output of the position sensing sensor SE2 during the driving of the registration roller 27. Thus, the controller 11 acquires deviation information indicating the degree of the deviation of the recording medium P from the target position Tp. Note that the deviation information includes a numerical value indicating the magnitude of the deviation and a direction indicating whether the deviation is to the right or left.

Upon acquiring the deviation information, the controller 11 determines the oscillating speed of the medium oscillating mechanism 34 according to the magnitude of the deviation. The oscillating speed of the medium oscillating mechanism 34 is a movement speed of the registration roller 27 along the medium width direction CD by the medium oscillating mechanism 34.

At this time, the controller 11 determines the direction of the oscillating speed of the medium oscillating mechanism 34 to be the reverse direction based on the direction of the deviation included in the deviation information. For example, when the recording medium P is deviated to the left, the registration roller 27 is swung to the right, and when the recording medium P is deviated to the right, the registration roller 27 is swung to the left.

The controller 11 determines the oscillating speed of the medium oscillating mechanism 34 with reference to table data that defines a correlation between the magnitude of the deviation and the oscillating speed of the medium oscillating mechanism 34. Alternatively, the controller 11 may calculate the oscillating speed of the medium oscillating mechanism 34 from the magnitude of the deviation by a predetermined calculation.

Note that the oscillating speed of the medium oscillating mechanism 34 should be increased or decreased so as to follow the conveyance speed of the recording medium P. Therefore, the controller 11 reads the setting value of the conveyance speed of the recording medium P from the conveyance condition of the recording medium P in the storage section 12. Next, the oscillating speed of the medium oscillating mechanism 34 obtained from the magnitude of the deviation is multiplied by a coefficient correlated with the conveyance speed of the recording medium P, thereby determining a final oscillating speed. Alternatively, a numerical value correlated with the conveyance speed of the recording medium P may be added to or subtracted from the oscillating speed of the medium oscillating mechanism 34 obtained from the magnitude of the deviation.

The controller 11 drives the motor at the finally determined oscillating speed and direction of the medium oscillating mechanism 34 to oscillate the registration roller 27 to one side in the medium width direction CD.

As described above, the controller 11 periodically reads the position sensing sensor SE2, and therefore, executes the first rectification control on the medium oscillating mechanism 34 every time.

### Control Executed by Controller: Second Rectification Control for Steering Mechanism of Intermediate Transfer Belt

The controller 11 executes second rectification control (belt correction control) of the first steering mechanism 62 for rectifying the deviation of the intermediate transfer belt 6 in the medium width direction CD during the conveyance of the intermediate transfer belt 6.

Upon sensing the deviation of the intermediate transfer belt 6 from the proper position in the medium width direction CD, the controller 11 controls the first steering mechanism 62 to eliminate the deviation. The deviation of the intermediate transfer belt 6 in the medium width direction CD with respect to the proper position is detected by the first deviation sensing device 63.

The controller 11 periodically monitors the output of the first deviation sensing device 63 while the intermediate transfer belt 6 is being conveyed. Next, the controller 11 acquires the deviation information including the magnitude and direction of the deviation of the intermediate transfer belt 6 from the proper position.

The controller 11 determines the rectification moving speed and direction of the intermediate transfer belt 6 according to the magnitude and direction of the deviation of the intermediate transfer belt 6 included in the deviation information. The controller 11 may use table data that defines the correlation between the magnitude of the deviation of the intermediate transfer belt 6 and the rectification moving speed of the intermediate transfer belt 6.

Further, the rectification moving speed of the intermediate transfer belt 6 in the medium width direction CD should be increased or decreased so as to follow the conveyance speed of the recording medium P. Therefore, the controller 11 reads the setting value of the conveyance speed of the recording medium P from the conveyance condition of the recording medium P in the storage section 12. Next, the rectification moving speed of the intermediate transfer belt 6 is multiplied by a coefficient correlated with the conveyance speed of the recording medium P to determine a final rectification moving speed. Alternatively, a numerical value correlated with the conveyance speed of the recording medium P may be added to or subtracted from the rectification moving speed of the intermediate transfer belt 6 obtained from the magnitude of the deviation.

The rectification moving speed and direction of the intermediate transfer belt 6 have the correlation with a tilt angle of the rotation shaft of the steering roller 61. Furthermore, there is the correlation between the tilt angle of the rotation shaft of the steering roller 61 and the shaft angle of the steering motor 621. Therefore, the controller 11 may use the table data that defines the correlation between the rectification moving speed of the intermediate transfer belt 6 and the shaft angle of the steering motor 621.

Therefore, when the controller 11 acquires the magnitude and direction of the deviation of the intermediate transfer belt 6, the controller 11 drives the steering motor 621 to have a corresponding shaft angle.

Since the controller 11 periodically reads the first deviation sensing device 63, the controller 11 executes the second rectification control for the first steering mechanism 62 each time.

### Control Executed by Controller: Second Rectification Control for Steering Mechanism of Fixing Belt

The controller 11 executes the second rectification control (belt correction control) of the second steering mechanism 55 for rectifying the deviation of the fixing belt 53 in the medium width direction CD during the conveyance of the fixing belt 53.

Upon sensing the deviation of the fixing belt 53 from the proper position in the medium width direction CD, the controller 11 controls the second steering mechanism 55 to eliminate the deviation. The deviation of the fixing belt 53 in the medium width direction CD with respect to the proper position is detected by the second deviation sensing device 56.

The controller 11 periodically monitors the output of the second deviation sensing device 56 during the conveyance of the fixing belt 53. Next, the controller 11 acquires the deviation information including the magnitude and direction of the deviation of the fixing belt 53 from the proper position.

The controller 11 determines the rectification moving speed and direction of the fixing belt 53 according to the magnitude and direction of the deviation of the fixing belt 53 included in the deviation information. The controller 11 may use the table data that defines the correlation between the magnitude of the deviation of the fixing belt 53 and the rectification moving speed of the fixing belt 53.

Furthermore, the rectification moving speed of the fixing belt 53 in the medium width direction CD should be increased or decreased so as to follow the conveyance speed of the recording medium P. Therefore, the controller 11 reads the setting value of the conveyance speed of the recording medium P from the conveyance condition of the recording medium P in the storage section 12. Next, the rectification moving speed of the fixing belt 53 is multiplied by the coefficient correlated with the conveyance speed of the recording medium P to determine a final rectification moving speed. Alternatively, a numerical value correlated with the conveyance speed of the recording medium P may be added to or subtracted from the rectification moving speed of the fixing belt 53 obtained from the magnitude of the deviation.

The speed and direction of the rectification moving speed of the fixing belt 53 are correlated with the tilt angle of the rotation shaft of the first heating roller 51. Furthermore, there is the correlation between the tilt angle of the rotation shaft of the first heating roller 51 and the shaft angle of the steering motor 551. Therefore, the controller 11 may use the table data defining the correlation between the rectification moving speed of the fixing belt 53 and the shaft angle of the steering motor 551.

Therefore, when the controller 11 acquires the magnitude and direction of the deviation of the fixing belt 53, the controller 11 drives the steering motor 551 to have a corresponding shaft angle.

The controller 11 periodically reads the second deviation sensing device 56, and thus executes the second rectification control for the second steering mechanism 55 each time.

### Control Executed by Controller: Correction Processing For Second Rectification Control

The recording medium P passing through the registration roller 27 may reach the intermediate transfer belt 6 or the fixing belt 53 and straddle therebetween. When the first rectification control is performed on the recording medium P in this state, the intermediate transfer belt 6 or the fixing belt 53 may be pulled by the oscillating of the recording medium P to move in the same direction.

Therefore, when the above-described straddling occurs, it is necessary to correct the rectification moving speed of the intermediate transfer belt 6 or the fixing belt 53 by the second rectification control.

First, the controller 11 determines the presence or absence of a straddling state between the registration roller 27 and the intermediate transfer belt 6 or the fixing belt 53. The conveyance distance from the registration roller 27 to the nip portion of the intermediate transfer belt 6 or the fixing belt 53 is design information and is a known value. Hereinafter, the conveyance distance from the registration roller 27 to the nip portion of the intermediate transfer belt 6 or the fixing belt 53 is referred to as an “inter-belt distance”.

The size of the recording medium P in the medium conveyance direction (hereinafter referred to as “medium feed length”) can be obtained from the conveyance conditions of the recording medium P in the storage section 12.

The controller 11 determines that the straddling state occurs in a case where the medium feed length is larger than the inter-belt distance.

Further, the controller 11 can determine whether or not the straddling state is currently occurring based on the elapsed time from the start of the driving of the registration roller 27.

While the straddling state is occurring, the controller 11 performs the correction processing on the rectification moving speed of the intermediate transfer belt 6 or the fixing belt 53 by the second rectification control.

Next, the content of the correction processing of the rectification moving speed by the second rectification control will be described. Here, a case where the intermediate transfer belt 6 is a target will be illustrated. The controller 11 periodically and repeatedly executes the correction processing while the straddling state occurs.

The controller 11 obtains the correction speed during the occurrence of the straddling state and corrects the rectification moving speed obtained in the second rectification control.

First, the controller 11 obtains a reference value of the correction speed. The reference value of the correction speed is determined based on the oscillating speed of the medium oscillating mechanism 34 determined in the first rectification control. Note that in principle, the direction of the correction speed is opposite to the direction of the oscillating speed of the medium oscillating mechanism 34.

Hereinafter, the oscillating speed of the medium oscillating mechanism 34 determined in the first rectification control is referred to as “oscillating speed A”. In addition, a reference value of the correction speed with respect to the rectification moving speed by the second rectification control is set as “correction speed B”.

For example, the controller 11 calculates the correction speed B by multiplying the oscillating speed A by a predetermined coefficient k1 (0<k1<1).

$$B = k 1 \cdot A$$

Note that this is merely an example, and addition or subtraction of a predetermined value may be performed on the oscillating speed A instead of the multiplication by the coefficient k1, or both of the addition and the subtraction may be performed to obtain the correction speed B.

For example, in a case where the recording medium P is oscillated to the left by the registration roller 27, the correction of a right movement component is performed on the belt 6. At this time, in a case where the rightward rectification moving speed is set for the belt 6 by the second rectification control, the correction for increasing the rightward movement component is performed. In contrast, in a case where the leftward rectification moving speed is set for the belt 6 by the second rectification control, the correction for decreasing the rightward movement component is performed.

In addition, in a case where the recording medium P is oscillated to the right by the registration roller 27, the reverse occurs.

Note that the value of the correction speed B may be greater than the rectification moving speed of the belt 6 determined by the second rectification control. In that case, the belt 6 moves in a direction opposite to the rectification moving speed determined by the second rectification control.

Next, the controller 11 further corrects the correction speed B serving as the reference value, based on a predetermined parameter. The predetermined parameters in this case are the “size in the conveyance direction FD,” the “size in the medium width direction CD,” and the “stiffness” of the recording medium P included in the conveyance conditions of the recording medium P.

As described above, the “size in the conveyance direction FD” of the recording medium P is abbreviated as the “medium feed length”. In addition, the “size in the medium width direction CD” of the recording medium P is abbreviated as “medium width”.

When the medium feed length is increased, the influence of the movement of the belt 6 pulled by the recording medium P oscillated by the registration roller 27 is reduced.

Therefore, the controller 11 performs correction in which the correction speed B is reduced according to the medium feed length. To be specific, the correction is performed by a value obtained by multiplying the medium feed length by a predetermined coefficient k2 (0<k2). Where “L” is the medium feed length and “B1” is the modified correction speed.

$$B 1 = B - k 2 \cdot L = k 1 \cdot A - k 2 \cdot L$$

When the medium width increases, the influence of the movement of the belt 6 pulled by the recording medium P oscillated by the registration roller 27 increases.

Therefore, the controller 11 makes a modification such that the correction speed B is increased in accordance with the medium width. To be specific, the correction is performed with a value obtained by multiplying the medium width by a predetermined coefficient k3 (0<k3). Where “W” is the medium width and “B2” is the modified correction speed.

$$B 2 = B 1 + k 3 \cdot W = k 1 \cdot A - k 2 \cdot L + k 3 \cdot W$$

When the stiffness increases, the influence of the movement of the belt 6 pulled by the recording medium P oscillated by the registration roller 27 increases.

Therefore, the controller 11 makes a modification such that the correction speed B is increased in accordance with the medium width. To be specific, the correction is performed with a value obtained by multiplying the stiffness by a predetermined coefficient k4 (0<k4). Where “G” is the stiffness and “B3” is the modified correction speed.

$$B 3 = B 2 + k 4 \cdot G = k 1 \cdot A - k 2 \cdot L + k 3 \cdot W + k 4 \cdot G$$

Although an example in which the correction of each parameter with respect to the correction speed B is performed by multiplying the numerical value of the parameter by a predetermined coefficient and performing addition or subtraction has been described, the present invention is not limited thereto.

For example, a coefficient may be determined for each numerical value of each parameter, and the correction may be performed by multiplying the correction speed B by the coefficient corresponding to the numerical value of each parameter.

Further, although it is preferable to correct each parameter with respect to the correction speed B, the correction may not necessarily be performed. Alternatively, the correction of each parameter for the correction speed B may be performed for any one or two of the medium feed length, the medium width, and the stiffness of the recording medium P.

Furthermore, the correction speed B is preferably set in consideration of the conveyance speed of the recording medium P. In this point, the correction speed B is obtained by multiplying the oscillating speed A by the coefficient k1, and the oscillating speed A is a numerical value in consideration of the conveyance speed of the recording medium P. Therefore, the correction speed B is a value obtained in consideration of the conveyance speed of the recording medium P.

Further, the correction speed B is preferably set in consideration of the oscillating direction of the recording medium P and the deviation direction of the belt 6.

In principle, the correction speed B is corrected in a direction opposite to the oscillating direction in order to reduce the influence of the oscillating direction of the recording medium P. Furthermore, for the correction speed B, the correction value by each parameter is also increased or decreased in consideration of each direction. Therefore, the modification values B1, B2, and B3 of the correction speed B are values in consideration of the oscillating direction of the recording medium P.

In addition, in the case of considering the deviation direction of the belt 6, the coincidence between the direction of rectifying the belt 6 and the direction in which the correction speed B acts on the belt 6 is considered. As described above, the direction in which the correction speed B acts on the belt 6 is opposite to the direction in which the registration roller 27 oscillates.

When the direction of rectifying the belt 6 and the direction in which the correction speed B acts on the belt 6 coincide with each other, the correction speed B may be adjusted to be increased. Further, when the direction in which the belt 6 is rectified and the direction in which the correction speed B acts on the belt 6 are opposite to each other, the correction speed B may be adjusted to be reduced.

Further, the controller 11 executes the correction processing of the rectification moving speed by the second rectification control also for the fixing belt 53 similarly to the case of the intermediate transfer belt 6.

The fixing belt 53 is positioned farther from the registration roller 27 than the intermediate transfer belt 6 is from the registration roller 27, and the intermediate transfer belt 6 is interposed between the fixing belt 53 and the registration roller 27. Therefore, the influence of the registration oscillation on the fixing belt 53 is smaller than that on the intermediate transfer belt 6. Therefore, in consideration of this, a value smaller than that of the intermediate transfer belt 6 is adopted as the coefficient k1 to k4 for obtaining the correction speed B and the correction values B1, B2, and B3.

### Operation Control During Conveyance of Recording Medium

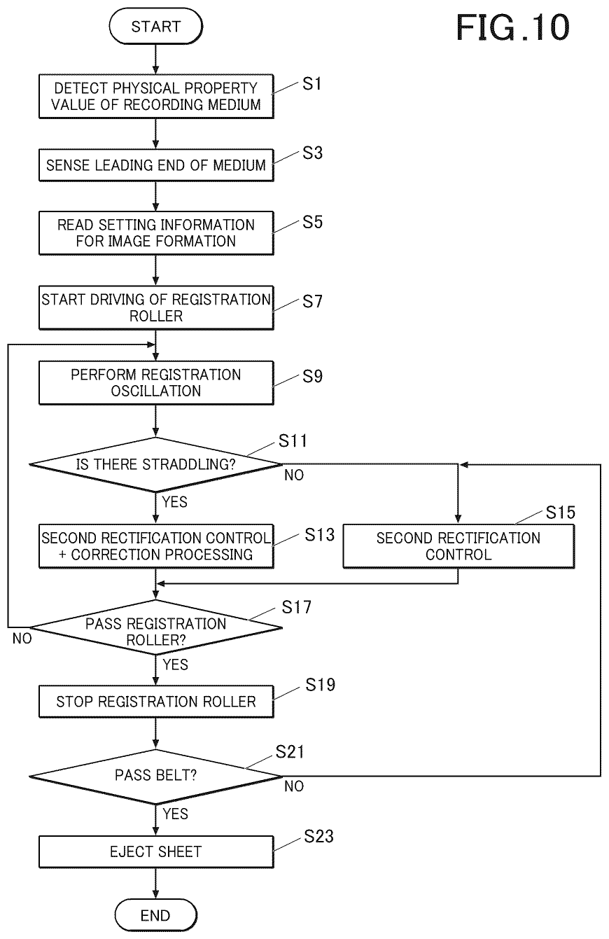

Operation control that the CPU of the controller 11 performs on the various sections of the image forming apparatus 100 while the recording medium P is being conveyed will be described with reference to the flowchart of FIG. 10.

When conveyance of the recording medium P by the medium conveyance section 20 starts and the recording medium P passes the media sensor 33, the controller 11 detects the physical property value of the recording medium P (S1). The thickness, moisture percentage, basis weight, and stiffness of the recording medium P detected by the media sensor 33 are saved in the storage section 12 as conveyance conditions of the recording medium P.

When the leading end of the recording medium P is sensed by the position sensing sensor SE2 (S3), the controller 11 reads the setting information of the image formation from the storage section 12 (S5). Thus, the controller 11 acquires conveyance conditions of the recording medium P, such as the conveyance speed of the recording medium P, the sizes of the recording medium P in the direction FD and the direction CD, the basis weight, and the stiffness.

The controller 11 also drives the registration motor 271 to start conveyance of the recording medium P by the registration roller 27 (S7).

Next, the controller 11 causes the leading end portion of the recording medium P to abut against the nip portion of the registration roller 27 to form a loop and causes the intermediate conveyance rollers 23 to 25 to be separated. Furthermore, the controller 11 starts detection of the deviation of the recording medium P in the medium width direction CD by the position sensing sensor SE2. Thus, when the deviation of the recording medium P is detected, the controller 11 determines the oscillating speed and direction of the recording medium P by the medium oscillating mechanism 34. As a result, the medium oscillating mechanism 34 is driven to oscillate the recording medium P along the medium width direction CD (S9).

Next, the controller 11 determines whether the straddling state of the recording medium P occurs between the registration roller 27 and the intermediate transfer belt 6 (S11).

When the straddling state occurs, the controller 11 executes the second rectification control and the correction processing thereof on the intermediate transfer belt 6 (S13).

That is, the controller 11 determines the rectification moving speed and direction of the intermediate transfer belt 6 on the basis of the output of the first deviation sensing device 63. Furthermore, the controller 11 calculates the correction speed B on the basis of the oscillating speed of the recording medium P and the recording medium feed length, the medium width, and the stiffness of the recording medium P. Next, the controller 11 drives the steering motor 621 at the rectification moving speed corrected by the correction speed B. Accordingly, it is possible to rectify the position of the intermediate transfer belt 6 in the medium width direction CD while suppressing the influence of the recording medium P being pulled.

Next, the controller 11 proceeds to step S17.

On the other hand, when the straddling state has not occurred, the controller 11 executes the second rectification control on the intermediate transfer belt 6 and does not perform the correction processing (S15).

That is, the controller 11 determines the rectification moving speed and direction of the intermediate transfer belt 6 on the basis of the output of the first deviation sensing device 63. Then, the controller 11 drives the steering motor 621 at the rectification moving speed.

Next, the controller 11 proceeds to step S17.

In step S17, the controller 11 determines whether the trailing end of the recording medium P has passed through the registration roller 27 (S17).

If not, the controller 11 returns the processing to step S9 and executes the processing in steps S9 to S17 again.

Note that the processing in steps S9 to S17 for the intermediate transfer belt 6 has been described in the above description of the operation. However, in parallel with this, the controller 11 also executes processing in steps S9 to S17 on the fixing belt 53.

Next, upon determination in step S17 that the recording medium P has passed through the registration roller 27, the controller 11 stops the registration roller 27 (S19).

Furthermore, the controller 11 determines whether the trailing end of the recording medium P has passed through the nip portion of the intermediate transfer belt 6 (S21).

If not, the controller 11 returns the process to step S15. The controller 11 executes the processing in steps S15 to S19 again and executes the second rectification control of the intermediate transfer belt 6.

The controller 11 also executes processing in steps S15 to S19 on the fixing belt 53 until the recording medium P passes through the nip portion.

When the recording medium P passes through the nip portion between the intermediate transfer belt 6 and the fixing belt 53, the controller 11 discharges the recording medium P to the ejection tray 29 (S23).

Then, the conveyance operation is finished.

In the operation control at the time of conveyance, the case where the correction process for the second rectification control is performed during the occurrence of the straddling state of the recording medium P has been exemplified, but the invention is not limited thereto.

For example, there is a case where occurrence of the straddling state of the recording medium P is known in advance from the length of the recording medium P. In this case, the correction processing of the second rectification control may be started before the recording medium P reaches the belts 6 and 53.

In this case, the correction processing of the second rectification control may be started at any timing until the recording medium P reaches the belt 6 or 53 from the registration roller 27.

Furthermore, it is preferable that the execution of the early start of the correction processing of the second rectification control can be set, for example, from the operation part 14. In this case, the setting of whether to perform the early start is preferably stored in the storage section 12 as the conveyance condition of the recording medium P. In this case, it is preferable to include setting information for specifying the early start timing of the correction processing of the second rectification control.

### Technical Effects of Embodiments of Invention

In the image forming apparatus 100, when the first rectification control is performed at the time of the occurrence of the straddling of the recording medium P, the controller 11 performs a correction for the second rectification control.

Therefore, the image forming apparatus 100 reduces the influence of the registration oscillation on the belt 6 or 53. Furthermore, it is possible to maintain the belt 6 or 53 at a more appropriate position to excellently perform image formation and improve image quality.

The controller 11 performs a correction to the second rectification control based on the oscillating speed of the recording medium P by the medium oscillating mechanism 34. Therefore, the rectification moving speed of the belts 6 and 53 is corrected according to the oscillating speed of the recording medium P, and the influence of the registration oscillation can be reduced more effectively.

The controller 11 performs a correction to the second rectification control based on the conveyance conditions of the recording medium P. The various conveyance conditions increase or decrease the influence of the oscillating speed of the recording medium P on the rectification moving speed of the belts 6 and 53.

Therefore, the controller 11 can suppress the influence of the conveyance conditions of the recording medium P and more effectively reduce the influence of the registration oscillation on the belts 6 and 53.

The controller 11 acquires conveyance conditions for the recording medium P from setting information for image formation. The setting information for image formation is stored in the storage section 12. Therefore, the controller 11 can more effectively reduce the influence of the registration oscillation on the belts 6 and 53 by referring to the storage section 12.

In addition, it is not necessary to acquire the conveyance conditions of the recording medium P from the outside or input them in advance.

The controller 11 acquires conveyance conditions for the recording medium P from the media sensor 33 that detects the recording medium P being conveyed. Therefore, it is not necessary to acquire the conveyance conditions of the recording medium P from the outside or to input the conveyance conditions in advance.

The controller 11 determines the correction amount for the second rectification control based on the oscillating speed of the recording medium P by the medium oscillating mechanism 34 and the size of the recording medium P. Therefore, it is possible to more appropriately correct the rectification moving speeds of the belts 6 and 53 that change due to these, and to more effectively reduce the influence of the registration oscillation.

The controller 11 determines a correction amount for the second rectification control, based on the oscillating speed of the recording medium P by the medium oscillating mechanism 34 and the stiffness of the recording medium P. Therefore, it is possible to more appropriately correct the rectification moving speeds of the belts 6 and 53 that change due to these, and to more effectively reduce the influence of the registration oscillation.

The controller 11 determines the correction amount for the second rectification control based on the oscillating speed of the recording medium P by the medium oscillating mechanism 34 and the conveyance speed of the recording medium P. Therefore, it is possible to more appropriately correct the rectification moving speeds of the belts 6 and 53 that change due to these, and to more effectively reduce the influence of the registration oscillation.

The controller 11 determines the correction amount for the second rectification control in consideration of the oscillating direction of the recording medium P by the medium oscillating mechanism 34 and the deviation direction of the belts 6 and 53. Therefore, the correction of the rectification moving speed of the belts 6 and 53 can be performed without excess or deficiency with respect to the combinations of these directions. That is, the image forming apparatus 100 can more effectively reduce the influence of the registration oscillation.

In a case where the straddling state of the recording medium P is predicted, the controller 11 can also start the correction for the second rectification control before the recording medium P reaches the belts 6 and 53.

Therefore, when the influence of the registration oscillation on the belt 6 or 53 is large, it is possible to cope with this from an early stage and effectively reduce the influence.

The controller 11 can also perform a correction to the second rectification control while the recording medium P is passing the belts 6 and 53.

Therefore, it is possible to perform correction for effectively reducing the influence of registration oscillation on the belt 6 or 53, which occurs in real time.

Since the belt whose rectification moving speed is to be corrected is the intermediate transfer belt 6, the rectification moving speed of the intermediate transfer belt 6 can be satisfactorily optimized. Thus, transfer at the time of image formation can be appropriately performed, and image quality can be improved.

Since the belt whose rectification moving speed is to be corrected is the fixing belt 53, it is possible to perform the rectification moving speed of the fixing belt 53 appropriate in a satisfactory manner. Thus, fixing at the time of image formation can be appropriately performed, and image quality can be improved.

Since the fixing belt 53 is supported by two shafts, the fixing belt 53 is likely to be influenced by registration oscillation. On the contrary, since the controller 11 performs a correction to the second rectification control, it is possible to promptly reduce the influence of the registration oscillation.

Since the intermediate transfer belt 6 is supported by three or more shafts, the influence of the registration oscillation can be reduced, but the belt 6 is less likely to move. In contrast, since the controller 11 performs a correction to the second rectification control, the belt 6 that has moved due to the registration oscillation can be returned to an appropriate position.

The belts 6 and 53 each contain polyimide as a base material and thus have high mechanical strength and excellent heat resistance. For this reason, good transfer to the intermediate transfer belt 6 and good fixing by the fixing belt 53 can be performed, and image quality can be improved.

### Others

Each embodiment of the present invention has been described above. However, the present invention is not limited to the above-described embodiment. For example, in the embodiment, a constituent element integrally formed of a single member may be replaced with a constituent element divided into a plurality of members and connected or fixed to each other. In addition, a constituent element configured by connecting a plurality of members may be replaced with a constituent element integrally formed by a single member. In addition, the details described in the embodiment can be appropriately modified without departing from the spirit and scope of the invention.

Although a nonvolatile memory, a hard disk, or the like is used in the above description as a computer-readable medium storing the program according to the present invention, the present invention is not limited to this example. As another computer-readable medium, a portable recording medium such as a CD-ROM can be applied. Furthermore, a carrier wave is also applied as a medium for providing data of the program according to the present invention via a communication line.

The detailed configuration and the detailed operation of the image forming apparatus can be appropriately changed without departing from the scope of the present invention.

Although embodiments of the present disclosure have been described and illustrated in detail, the disclosed embodiments are made for purposes of illustration and example only and not limitation. The scope of the present disclosure should be interpreted by terms of the appended claims.

1. An image forming apparatus that performs image formation on a recording medium by a plurality of processes, the image forming apparatus comprising:
a medium oscillating mechanism that oscillates the recording medium along a medium width direction intersecting a conveyance direction of the recording medium;
a medium sensing section that senses a position of an end of the recording medium in the medium width direction; and
a belt correction mechanism that is configured to correct a position of a belt in the medium width direction, the belt executing one of processes of the image formation on the recording medium;
a belt sensing section that senses the position of the end of the belt in the medium width direction; and
a hardware processor that performs first rectification control in which the medium oscillating mechanism rectifies the position of the end of the recording medium based on sensing by the medium sensing section, and second rectification control in which the belt correction mechanism rectifies the position of the end of the belt based on sensing by the belt sensing section,
wherein the hardware processor performs a correction to the second rectification control in a case in which the first rectification control is performed with the recording medium straddling both the medium oscillating mechanism and the belt.

2. The image forming apparatus according to claim 1, wherein the hardware processor performs a correction to the second rectification control based on an oscillating speed of the recording medium by the medium oscillating mechanism.

3. The image forming apparatus according to claim 2, wherein the hardware processor performs a correction to the second rectification control based on a conveyance condition of the recording medium.

4. The image forming apparatus according to claim 3, wherein the conveyance condition of the recording medium is acquired from setting information for the image formation.

5. The image forming apparatus according to claim 3, wherein the conveyance condition of the recording medium is acquired from the medium sensing section that detects the recording medium that is conveyed.

6. The image forming apparatus according to claim 3, wherein the hardware processor determines a correction amount for the second rectification control based on the oscillating speed of the recording medium by the medium oscillating mechanism and a size of the recording medium included in the conveyance condition of the recording medium.

7. The image forming apparatus according to claim 3, wherein the hardware processor determines a correction amount for the second rectification control based on the oscillating speed of the recording medium by the medium oscillating mechanism and a stiffness of the recording medium included in the conveyance condition of the recording medium.

8. The image forming apparatus according to claim 3, wherein the hardware processor determines a correction amount for the second rectification control based on the oscillating speed of the recording medium by the medium oscillating mechanism and a conveyance speed of the recording medium included in the conveyance condition of the recording medium.

9. The image forming apparatus according to claim 3, wherein the hardware processor determines a correction amount for the second rectification control in consideration of an oscillation direction of the recording medium by the medium oscillating mechanism and a deviation direction of the belt.

10. The image forming apparatus according to claim 1, wherein in a case in which it is predicted that the first rectification control will be performed with the recording medium straddling both the medium oscillating mechanism and the belt, the hardware processor starts a correction of the second rectification control before the recording medium reaches the belt.

11. The image forming apparatus according to claim 1, wherein the hardware processor performs a correction to the second rectification control while the recording medium is passing the belt.

12. The image forming apparatus according to claim 1, wherein the belt is a transfer belt that performs a transfer process.

13. The image forming apparatus according to claim 1, wherein the belt is a fixing belt that performs a fixing process.

14. The image forming apparatus according to claim 1, wherein the belt is supported by two shafts.

15. The image forming apparatus according to claim 1, wherein the belt is supported by three or more shafts.

16. The image forming apparatus according to claim 1, wherein a base material of the belt is polyimide.

17. A non-transitory computer-readable storage medium storing a program that controls a computer of an image forming apparatus including, a medium oscillating mechanism that oscillates a recording medium along a medium width direction intersecting a conveyance direction of the recording medium, a medium sensing section that senses a position of an end of the recording medium in the medium width direction, a belt correction mechanism that is configured to correct a position of a belt in the medium width direction, the belt executing one of processes of the image formation on the recording medium, and a belt sensing section that senses the position of the end of the belt in the medium width direction, the program causing the computer to execute the following:
performing first rectification control in which the medium oscillating mechanism rectifies the position of the end of the recording medium based on sensing by the medium sensing section,
performing second rectification control in which the belt correction mechanism rectifies the position of the end of the belt based on sensing by the belt sensing section, and
performing a correction to the second rectification control in a case in which the first rectification control is performed with the recording medium straddling both the medium oscillating mechanism and the belt.
